(19) United States
(12) Patent Application Publication
(10) Pub. No.: US 2022/0227138 A1
(43) Pub. Date: Jul. 21, 2022

(54) PRINTERS WITH REFILLABLE PRINTING FLUID RESERVOIRS

(71) Applicant: Hewlett-Packard Development Company, L.P., Spring, TX (US)

(72) Inventors: Paul Allan Osborne, Vancouver, WA (US); Wesley Ryan Schalk, Vancouver, WA (US); Kris McKinley English, Vancouver, WA (US)

(73) Assignee: Hewlett-Packard Development Company, L.P., Spring, TX (US)

(21) Appl. No.: 17/614,584

(22) PCT Filed: Sep. 11, 2019
(86) PCT No.: PCT/US2019/050623

§ 371 Date: Nov. 29, 2021

(51) Int. Cl. B41J 2/175

(52) U.S. Cl. CPC B41J 2/17509; B41J 2/17596; B41J 2/17513

(57) ABSTRACT

An example printing system includes a housing with an interior, a printing fluid reservoir arranged within the interior of the housing, a charging conduit fluidly coupled to the printing fluid reservoir, and a bottle seat. The bottle seat is fixed to the housing and defines a charging port. The charging port is in fluid communication with the printing fluid reservoir through the charging conduit to convey refill printing fluid received at the charging port to the printing fluid reservoir through the charging conduit. Methods of refilling printing systems are also described.

### BACKGROUND

A printer is a device that applies a material (e.g., ink, toner, dye, agent, etc.) to a medium (e.g., paper). Printers can vary in type, and examples include laser printers, inkjet printers, solid ink printers, thermal printers, dye-sublimation printers, 3D printers, and others. The substance the printer applies to the medium is consumed during printing and therefore typically requires replenishment. In some printer devices replenishment is accomplished by adding additional material to supplied from an external bottle. The material is generally added by opening the printer to access an internal reservoir, coupling the bottle, flowing material from the bottle to the reservoir via gravity, and thereafter uncoupling the bottle and closing the printer.

### BRIEF DESCRIPTION OF THE DRAWINGS

The following detailed description references the drawings, in which:

FIG. 1 is a schematic view of a printing system constructed in accordance with the present disclosure according to an example, showing the printing system using a printing fluid pump to draw printing fluid from a printing fluid reservoir and communicate the printing fluid to a print head assembly;

FIG. 2 is a schematic view of the printing system of FIG. 1, showing the printing system refilling the printing fluid reservoir by drawing printing fluid from a printing fluid refill bottle and communicate the printing fluid to the printing fluid reservoir with the printing fluid pump;

FIG. 3 is a schematic view of the printing system of FIG. 1, showing the printing system recirculating printing fluid from the printing fluid reservoir through a supply conduit and charging conduit using the printing fluid pump;

FIG. 4 is a schematic view of the printing system of FIG. 1, showing the printing system returning printing fluid to the printing fluid refill bottle using the printing fluid pump when the printing fluid reservoir is overfilled;

FIG. 5 is a schematic view of the printing system of FIG. 1, showing the printing system purging excess printing fluid in the printing fluid reservoir through the print head assembly using the printing fluid pump; and

FIG. 6 is a block diagram of a method of refilling a printing fluid reservoir in a printing system according to a non-limiting example of the method.

### DETAILED DESCRIPTION

The systems and methods described herein provide printing fluid refilling for the printing fluid reservoir within a printing system from a charging port located on the exterior of the printing system housing. The charging port is connected to the printing fluid reservoir by a charging conduit, which fluidly couples the charging port to a printing fluid pump and allows the printing fluid reservoir to be positioned within the interior of the printing system independent of the position of the charging port, simplifying the arrangement of the printing system. In certain examples a printing fluid pump is employed to draw printing fluid from a printing fluid refill bottle, reducing the amount of time required to add additional printing fluid to the printing system. In accordance with certain examples the charging conduit is connected to the printing system supply conduit between the printing fluid reservoir and the printing fluid pump, allowing the printing fluid pump employed to communicate printing fluid to the print head assembly to also drive refill printing fluid from the printing fluid refill bottle into the printing fluid reservoir. It is also contemplated that, in certain examples, the printing fluid pump can be operated at a different speed during refilling than during printing to limit the time required for refilling the printing fluid reservoir.

In traditional printing systems, such as a continuous printing fluid system, printing fluid consumed during printing is periodically replaced. Printing fluid refilling generally requires that the printing fluid reservoir be accessed by opening the printing system and coupling a printing fluid refill bottle to the printing fluid reservoir. Once the printing fluid refill bottle is coupled to the printing fluid reservoir, refill printing fluid is transferred from the printing fluid refill bottle to the printing fluid reservoir, generally using gravity to flow the refill printing fluid from the refill printing fluid bottle and into the printing fluid reservoir through a fill port on, e.g., defined by and local to, the printing fluid reservoir. The printing fluid refill bottle is thereafter uncoupled from the printing fluid reservoir, the housing of the printing system closed, and the printing system returned to operation. While generally acceptable for its intended purpose, printing fluid refilling in such printing systems can be relatively slow. Further, the need to position the printing fluid reservoir such that the fill port is accessible to the user can limit the size and/or positioning of the printing fluid reservoir within the printing system.

The present systems and techniques overcome these shortcomings by providing a bottle seat located on the exterior of the printing system and remote from the printing fluid reservoir. Arranging the bottle seat remotely with respect to the printing fluid reservoir eliminates the need for the user to access the interior of the printing system to refill the printing fluid reservoir. Arranging the bottle seat remotely also removes the need to position the printing fluid reservoir in a location where the user can access the printing fluid reservoir for refilling.

An example of an additional benefit of the bottle seat is the ability for connection of the printing fluid pump between the bottle seat and the printing fluid reservoir. Placement of the printing fluid pump between the bottle seat and the printing fluid reservoir allows the printing fluid pump to draw the printing fluid from an printing fluid refill bottle seated on the bottle seat, increasing the rate at which printing fluid is added to the printing fluid reservoir and reducing the time required for refilling the printing fluid reservoir when gravity is the motive force. Further, it is contemplated that the speed of the printing fluid pump can be increased relative to that of printing, further reducing the time required to refill the printing fluid reservoir. Another example benefit is the capability to fluidly connect the printing fluid reservoir to the bottle seat. Fluid connection of the printing fluid reservoir to the bottle seat allows the printing fluid pump to return excess printing fluid from the printing fluid reservoir to the printing fluid refill bottle, reducing (or eliminating entirely) the need for the user or the controller 122 to monitor the printing fluid refill process to prevent overfilling the printing fluid reservoir.

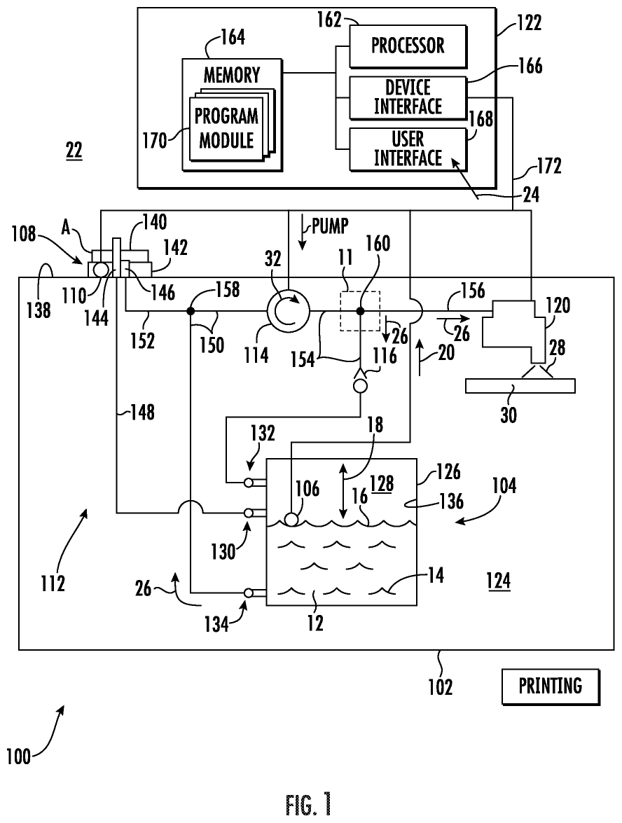

FIGS. 1-5 include components, modules, engines, etc. according to various examples as described herein. In different examples, more, fewer, and/or other components, modules, engines, arrangements of components/modules/engines, etc. can be used according to the teachings described herein. In addition, the components, modules, engines, etc. described herein are implemented as software modules executing machine-readable instructions, hardware modules, or special-purpose hardware (e.g., application specific hardware, application specific integrated circuits (ASICs), field programmable gate arrays (FPGAs), embedded controllers, hardwired circuitry, etc.), or some combination of these.

Referring to FIG. 1, an example printing system 100 is shown. The printing system 100 includes a housing 102, a printing fluid reservoir 104, a printing fluid level sensor 106, and a bottle seat 108. The printing system 100 also includes a bottle-detect sensor 110, a printing fluid distribution network 112, a printing fluid pump 114, and a pressure control device 116. The printing system 100 additionally includes a printing fluid-air separator 118, a print head assembly 120, and a controller 122.

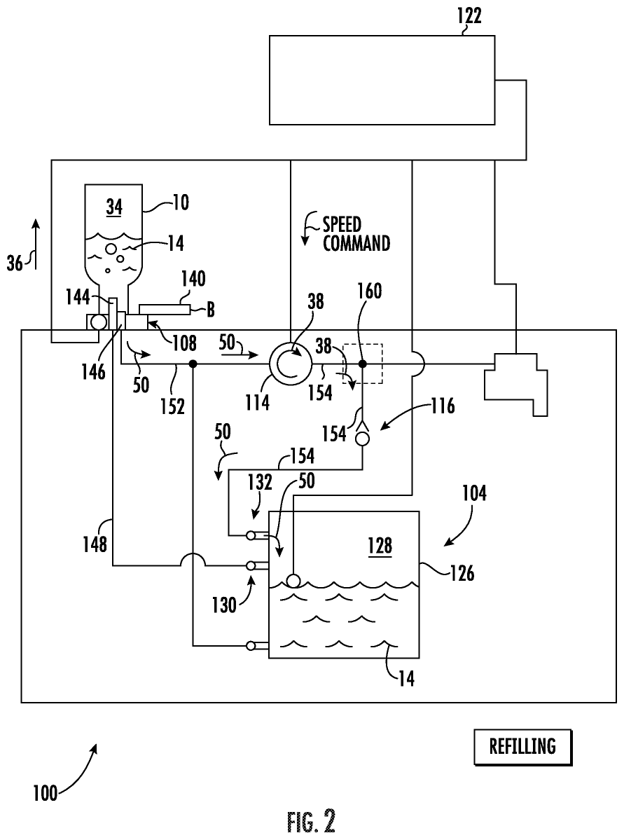

The housing 102 supports the bottle seat 108 and has an interior 124. The bottle-detect sensor 110, e.g., a switch arranged to provide a voltage when triggered, is arranged proximate the bottle seat 108 to detect the presence or absence of a printing fluid refill bottle 10 (shown in FIG. 2) at the bottle seat 108. The printing fluid reservoir 104, the printing fluid distribution network 112, and the print head assembly 120 are arranged within the interior 124 of the housing 102. The printing fluid pump 114, the pressure control device 116, the printing fluid-air separator 118, and the controller 122 are also arranged within the interior 124 of the housing 102.

The printing fluid reservoir 104 has a reservoir body 126 with an interior 128. The reservoir body 126 defines a reservoir body vent orifice 130, a reservoir body inlet orifice 132, and a reservoir body outlet orifice 134 to provide fluid communication between the interior 128 of the reservoir body 126 and the printing fluid distribution network 112. The printing fluid distribution network 112 in turn provides fluid communication between the printing fluid reservoir 104 and the print head assembly 120. The printing fluid distribution network 112 also provides fluid communication between the printing fluid reservoir 104 and the bottle seat 108.

A charge of printing fluid 12, e.g., ink, is disposed within the interior 128 of the reservoir body 126. The charge of printing fluid 12 includes liquid printing fluid 14 with a printing fluid surface 16. The printing fluid surface 16 is disposed within the interior 128 of the reservoir body 126 and defines an ullage space 18 between the printing fluid surface 16 and an interior surface 136 of the reservoir body 126. As shown in FIG. 1 a printing fluid level sensor 106 is in communication with the interior 128 of the reservoir body 126, the printing fluid level sensor 106 arranged to communicate a signal 20 indicative of the amount of the liquid printing fluid 14, e.g., by reporting the location of printing fluid surface 16.

The bottle seat 108 is fixed to an exterior 138 of the housing 102, is configured to provide fluid communication with the interior 128 of the reservoir body 126 and cooperates with a closure 140. In this respect the bottle seat 108 has a seat body 142.

The seat body 142 defines a vent port 144 and a charging port 146. The vent port 144 is co-located with the charging port 146 at the bottle seat 108 and is fluidly coupled to the interior 128 of the reservoir body 126 by the printing fluid distribution network 112. The charging port 146 is also fluidly coupled to the interior 128 of the reservoir body 126. The closure 140 is movable between a first position A (e.g., a closed position), wherein the closure 140 abuts the seat body 142 and fluidly separates the charging port 146 from the external environment 22, and a second position B (e.g., an open position), wherein the closure 140 is spaced apart from the seat body 142 and the charging port 146 is in fluid communication with the external environment 22. It is contemplated that the vent port 144 be in fluid communication with the external environment 22 when the closure 140 is in both the first position A and the second position B.

The printing fluid distribution network 112 fluidly couples the printing fluid reservoir 104 to the bottle seat 108 and the print head assembly 120. In this respect the printing fluid distribution network 112 includes a vent conduit 148, a supply conduit 150, and a charging conduit 152. The printing fluid distribution network 112 also includes a return conduit 154, a print head assembly conduit 156, a suction-side union 158, and a pressure-side union 160.

The vent conduit 148 is arranged within the interior 124 of the housing 102 and fluidly couples the reservoir body 126 to the bottle seat 108. More specifically, the vent conduit 148 is connected on a first end to the reservoir body 126 at the reservoir body vent orifice 130, and to the vent port 144 defined by the bottle seat 108 on a second end of the vent conduit 148.

The supply conduit 150 is also arranged within the interior 124 of the housing 102 and fluidly couples the reservoir body 126 to the printing fluid pump 114. More specifically, the supply conduit 150 is connected at a first end to the reservoir body 126 at the reservoir body outlet orifice 134, and to the printing fluid pump 114 at a second end of the supply conduit 150. The suction-side union 158 is arranged along a length of the supply conduit 150 between the reservoir body outlet orifice 134 and the printing fluid pump 114. The suction-side union 158 in turn fluidly couples the charging port 146 defined by the seat body 142 to printing fluid pump 114 through the charging conduit 152. The charging conduit 152 fluidly couples the charging port 146 to the printing fluid reservoir 104 to convey refill printing fluid received at the charging port 146 through the interior 124 of the housing 102 and to the printing fluid reservoir 104.

The return conduit 154 is additionally arranged within the interior 124 of the housing 102 and fluidly couples the printing fluid pump 114 to the reservoir body 126. More specifically, the return conduit 154 is connected at a first end to the printing fluid pump 114, and to the reservoir body inlet orifice 132 of the reservoir body 126 at an opposite second end of the return conduit 154. The pressure-side union 160 is arranged along a length of the return conduit 154 between the reservoir body inlet orifice 132 and the printing fluid pump 114, and the pressure control device 116 is arranged along the length of the return conduit 154 between the pressure-side union 160 and the reservoir body inlet orifice 132. The pressure-side union 160 in turn fluidly couples the print head assembly 120 to the printing fluid pump 114 through the pressure-side union 160 and a portion of the return conduit 154 extending between the pressure-side union 160 and the printing fluid pump 114.

The controller 122 includes a processor 162, a memory 164, a device interface 166, and a user interface 168. The device interface 166 operably connects the processor 162 to the printing fluid pump 114 and the print head assembly 120, e.g., via a wired or wireless link 172. The device interface 166 also places the processor 162 in communication with the bottle-detect sensor 110 and the printing fluid level sensor 106. Communication with the processor 162 in turn enables the printing fluid level sensor 106 to provide the signal 20 indicative of the amount of printing fluid 12 disposed within the interior 128 of the reservoir body 126 to the processor 162. Communication with the processor 162 also enables the bottle-detect sensor 110 to provide a bottle-present signal 36 (shown in FIG. 2) indicative of presence/absence of the printing fluid refill bottle 10 (shown in FIG. 2) at the bottle seat 108. In this respect the bottle-detect sensor 110 is operably associated with the bottle seat 108, i.e., seating a refill bottle on the bottle seat 108 cause the bottle-detect sensor 110 to issue the bottle-present signal 36 indicating presence of the printing fluid refill bottle.

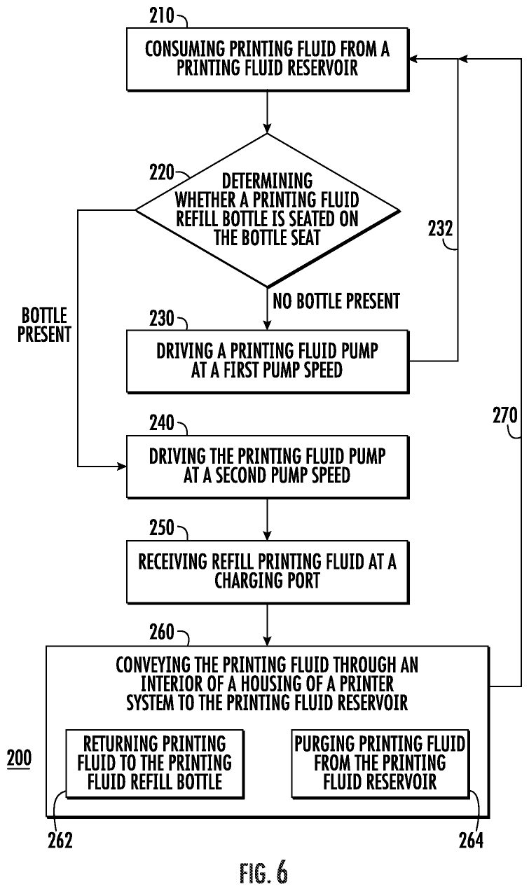

The processor 162 is disposed in communication with the user interface 168, the user interface 168 in turn configured to communicate a user input 24 to processor 162. The memory 164 in turn has a plurality of program modules 170 recorded on the memory 164 that, when read by the processor 162, cause the processor 162 to execute certain operations. Among the operations are those of a method 200 (shown in FIG. 6) of refilling a printing fluid reservoir, e.g., the printing fluid reservoir 104, as will be described. It is contemplated that the processor 162 can be implemented with circuitry, software, or a combination of circuitry and software.

As shown in FIG. 1, during printing, the controller 122 causes the printing fluid pump 114 to communicate a printing fluid flow 26 to the print head assembly 120, which in turn deposits printing fluid 28 from the printing fluid flow 26 on a substrate 30, e.g., a media sheet or a printed article. In this respect the controller drives the printing fluid pump 114 at a first pump speed 32. The printing fluid pump 114 in turn pulls the printing fluid flow 26 from the reservoir body outlet orifice 134, through the supply conduit 150, and to the printing fluid pump 114. Once at the printing fluid pump 114 the printing fluid pump drives the printing fluid flow 26 (or a portion thereof) to the print head assembly 120, which deposits the printing fluid 28 on the substrate 30.

As will be appreciated art in view of the present disclosure, the volume of liquid printing fluid 14 within the printing fluid reservoir 104 decreases during printing. Since the volume decrease can increase the work necessary to communicate the printing fluid flow 26 to the print head assembly 120 the vent conduit 148 provides fluid communication between the external environment 22 and the ullage space 18 within the interior 128 of the reservoir body 126. Fluid communication between the external environment 22 and the ullage space 18 in turn maintains pressure therein substantially equivalent to ambient pressure in the external environment 22, allowing the printing fluid pump 114 to be relatively small and/or compact.

As also shown in FIG. 1, the closure 140 is in the first position A. As such no fluid flows between suction-side union 158 and the charging port 146. In certain examples the closure 140 can be in fluid-tight engagement with the seat body 142, limiting (or eliminating entirely) the need to remove entrained air from the printing fluid flow 26. In accordance with certain examples the closure 140 is loosely fit to the seat body 142, simplifying the manufacturing of the seat body 142 and/or the closure 140—air ingested and entrained in the printing fluid flow 26 being removed by the printing fluid-air separator 118 (which is optional).

With reference to FIG. 2, the printing system 100 is shown during refilling. To refill the printing fluid reservoir 104 the closure 140 is moved to the second position B and the printing fluid refill bottle 10 seated on the bottle seat 108. Seating the printing fluid refill bottle 10 on the bottle seat 108 fluidly couples the printing fluid refill bottle 10 to the printing fluid reservoir 104. More specifically, the seating the printing fluid refill bottle 10 on the bottle seat 108 places an interior 34 of the printing fluid refill bottle 10 in fluid communication with the interior 128 of the reservoir body 126 through both the vent port 144 and the charging port 146. The vent port 144 in turn fluidly couples the printing fluid refill bottle 10 to the interior 128 of the reservoir body 126 through the vent conduit 148 and the reservoir body vent orifice 130. The charging port 146 also fluidly couples the printing fluid refill bottle 10 to the printing fluid pump 114 through the charging conduit 152, the pressure-side union 160, and a portion of the supply conduit 150 connecting the pressure-side union 160 to the printing fluid pump 114.

Seating the printing fluid refill bottle 10 on the bottle seat 108 also triggers the bottle-detect sensor 110. In this respect the bottle-detect sensor 110 generates a bottle-present signal 36 indicating presence of the printing fluid refill bottle 10 at the bottle seat 108. The wired or wireless printing fluid 172 conveys the bottle-present signal 36 to the controller 122, which responds by turning on the printing fluid pump 114 by issuing a speed command to the printing fluid pump 114. Once turned on by the controller 122 in response to the bottle-present signal 36, the printing fluid pump 114 drives a flow of refill printing fluid 50 through the printing fluid pump 114 to the interior 128 of the reservoir body 126. More specifically, the printing fluid pump 114 drives the flow of refill printing fluid 50 through the return conduit 154 and the pressure control device 116, and therethrough into the printing fluid reservoir 104. In certain examples movement of the closure 140 to the second position B causes the print head assembly 120 to cease printing, e.g., upon completion of the print job in process at the time the closure 140 is moved to the second position B.

It is contemplated that the controller 122 causes the printing fluid pump to operate at a second printing fluid pump speed 38, the second printing fluid pump speed 38 being enough to cause the pressure control device 116 to open. In accordance with certain examples, the second printing fluid pump speed 38 can be greater than that of the first pump speed 32 (shown in FIG. 1). In certain examples the second printing fluid pump speed 38 is about twice the speed of the first pump speed 32. As will be appreciated in view of the present disclosure, air displaced from the interior 128 of the reservoir body 126 flows from the ullage space 18 to the interior of the printing fluid refill bottle 10 through the vent conduit 148 and the vent port 144, limiting the amount of work required by the printing fluid pump 114 to drive the flow of refill printing fluid 50 to the printing fluid reservoir 104 while retaining sealing of the printing system 100 during refilling.

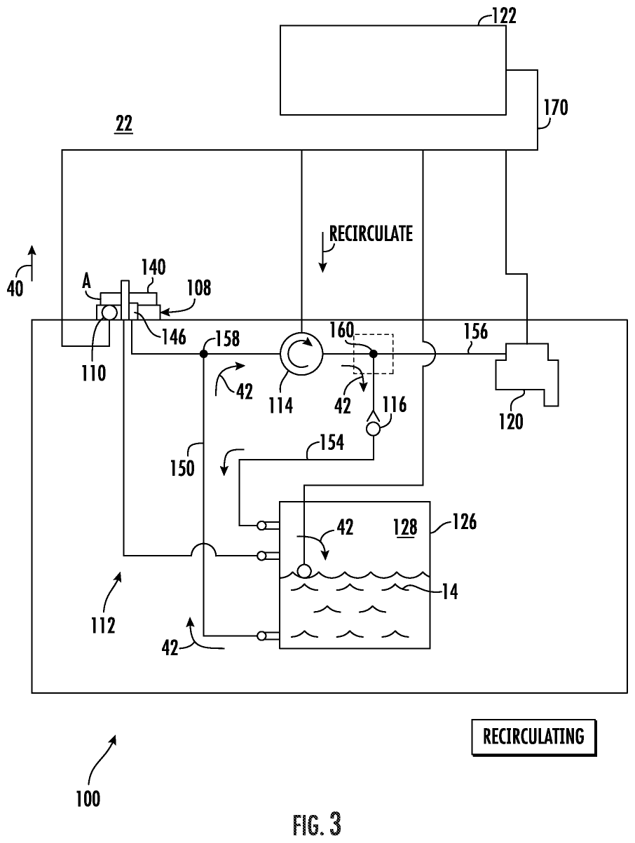

With reference to FIG. 3, the printing system 100 is shown recirculating the liquid printing fluid 14 from within the interior 128 of the reservoir body 126 through the printing fluid pump 114. Recirculation of the liquid printing fluid 14 occurs when no refill bottle, e.g., the printing fluid refill bottle 10 (shown in FIG. 2) is present at the bottle seat 108 and the print head assembly 120 is inactive. More specifically, when no printing fluid refill bottle 10 is present at the bottle seat 108 the bottle-detect sensor 110 provides an indication that no bottle is present at the bottle seat 108. In certain examples the indication is provided by absence of the bottle-present signal 36 (shown in FIG. 2). In accordance with certain examples the indication is provided by a signal 40 generated by the bottle-detect sensor 110 and communicated to the controller 122 by the wired or wireless printing fluid 172. It is also contemplated that the indication can be provided by moving the closure 140 to the first position A.

When the controller 122 receives indication (or discerns) that no refill bottle is present at the bottle seat 108, and the print head assembly 120 is idle (i.e., no printing is occurring), the controller 122 recirculates the liquid printing fluid 14 through a portion of the printing fluid distribution network 112. In this respect the controller 122 causes the printing fluid pump 114 to draw a recirculation printing fluid flow 42 from the interior 128 of the reservoir body 126 through the supply conduit 150 and the pressure-side union 160, and thereafter to the interior 128 of the reservoir body 126 through the return conduit 154 and the pressure control device 116.

It is contemplated that, during recirculation, the closure 140 provides sealing enough to limit (or eliminate entirely) ingestion of air from the external environment 22 through the charging port 146. It is also contemplated that, during recirculation, the print head assembly 120 fluidly isolates the pressure-side union 160 and the print head assembly conduit 156 from the external environment 22 such that substantially none of the recirculation printing fluid flow 42 enters the print head assembly conduit 156. This allows the printing system 100 to retain the liquid printing fluid 14 in a ready-to-use state while limiting printing fluid communication within portions of the printing fluid distribution network 112 beyond the suction-side union 158 and the pressure-side union 160.

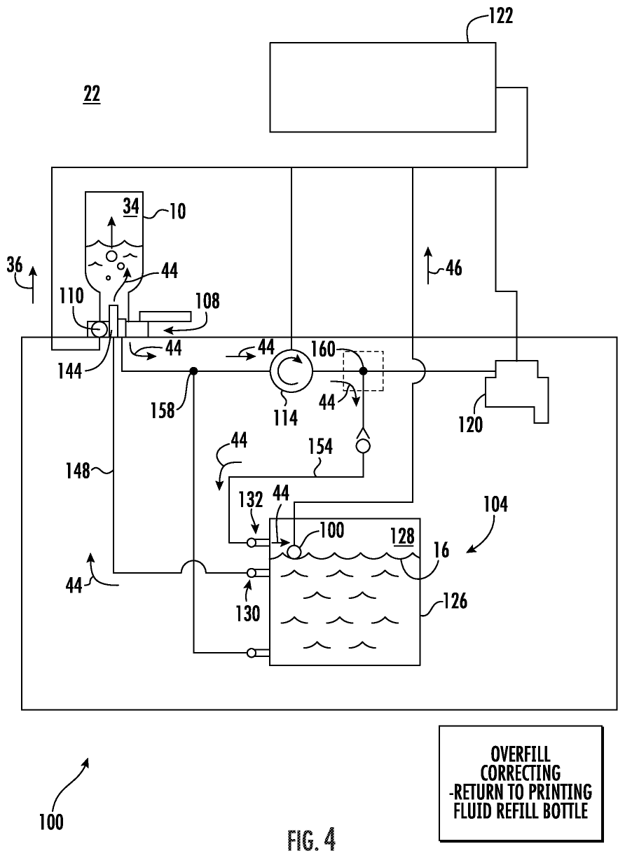

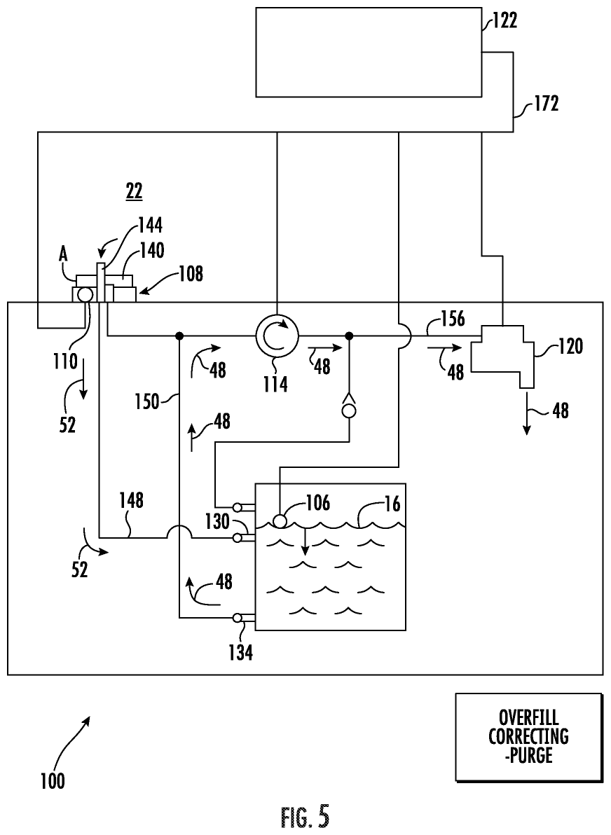

With reference to FIGS. 4 and 5, the printing system 100 is shown correcting for overfill via return of printing fluid to the printing fluid refill bottle 10 and via purge of the vent conduit 148 of residual printing fluid, respectively. As will be appreciated in view of the present disclosure, some printing systems allow the printing system printing fluid reservoir to overfill, potentially causing the printing fluid reservoir orifice to become submerged. To correct for overfill the printing system 100 is configured to return printing fluid to the printing fluid refill bottle 10 via a return printing fluid flow 44 (shown in FIG. 4) when the printing fluid refill bottle 10 is seated on the bottle seat 108, and is additionally configured to purge residual printing fluid from vent conduit 148 via a print job printing fluid flow 48 (shown in FIG. 5) when no printing fluid refill bottle is present at the bottle seat 108.

Referring to FIG. 4, overfill correction by return of printing fluid to the printing fluid refill bottle 10 is shown. Return of printing fluid from the printing fluid reservoir 104 begins when the printing fluid surface 16 within the printing fluid reservoir 104 rises above the reservoir body vent orifice 130. Once above the reservoir body vent orifice 130 the printing fluid surface 16 fluidly separates the ullage space 18 (shown in FIG. 1) from the reservoir body vent orifice 130. Fluid separation of the ullage space 18 from the reservoir body vent orifice 130 causes printing fluid thereafter introduced into the printing fluid reservoir 104 by operation of the printing fluid pump 114 to increase pressure within the ullage space 18. Pressure increase within the ullage space 18 in turn urges printing fluid from within the printing fluid reservoir 104 through the reservoir body vent orifice 130, through the vent conduit 148, and to the printing fluid refill bottle 10 via the vent port 144 as the return printing fluid flow 44. As will be appreciated in view of the present disclosure, the return printing fluid flow 44 generated by the pressure imbalance limits the amount of printing fluid that can be added to the printing fluid reservoir 104—reducing (or eliminating entirely) the possibility of overfilling of the printing fluid reservoir 104. This allows a user, for example, to seat a printing fluid refill bottle at the bottle seat 108 having more printing fluid therein than the printing fluid reservoir 104 may be in a condition receive. In certain examples the effective flow area of the vent port 144 in relation to the charging port 146, in conjunction with the speed of the printing fluid pump 114, determines the height of the printing fluid surface 16 required to initiate return of printing fluid from the printing fluid reservoir 104 to the printing fluid refill bottle 10.

Referring to FIG. 5, vent tube purging is shown. When the bottle-detect sensor 110 indicates that the printing fluid refill bottle 10 (shown in FIG. 2) has been removed from the bottle seat 108 the controller 122 turns off the printing fluid pump 114. Turning off the printing fluid pump 114 ceases communication of printing fluid through the vent conduit 148. In some circumstances residual printing fluid can remain within the vent conduit 148, e.g., when the reservoir body vent orifice 130 is submerged within the printing fluid 12 contained with the interior 128 of the printing fluid reservoir 104, subsequent to the printing fluid reservoir 104 becoming overfilled. In such event it is contemplated that the printing system 100 purge the vent conduit 148 during subsequent operation of the printing system 100.

Specifically, upon receipt of a print job, the controller 122 turns on the printing fluid pump 114 and the print head assembly 120. Turning on the print head assembly 120 causes the print head assembly 120 to issue a print job printing fluid flow 48, e.g., to the substrate 30 (shown in FIG. 1), associated with the print job. Turning on the printing fluid pump 114 causes the printing fluid pump 114 to draw printing fluid from the reservoir body outlet orifice 134 to form the print job printing fluid flow 48, which the printing fluid pump 114 draw through the supply conduit 150 and pushes to the print head assembly 120 through the print head assembly conduit 156.

As printing fluid is drawn from the printing fluid reservoir 104 the printing fluid surface 16 drops, shown in FIG. 5 with a downward arrow extending from the printing fluid surface 16. Drop in the printing fluid surface 16 in turn reduces pressure within the ullage space 18 (shown in FIG. 1) defined within the interior 128 of the printing fluid reservoir 104 and the printing fluid surface 16 relative to pressure in the external environment 22. The pressure differential between the external environment 22 and the ullage space 18 urges residual printing fluid inhabiting the vent conduit 148 into the interior 128 of the printing fluid reservoir 104 through the reservoir body vent orifice 130 as a printing fluid purge flow 52. It is contemplated that the printing fluid purge flow 52 continue until such time as the vent conduit is clear, at which point pressure within the ullage space 18 substantially equalizes with that of the external environment 22—the vent conduit 148 at that point being substantially purged of residual printing fluid.

With reference to FIG. 6, the method 200 of adding printing fluid to a printing system, e.g., the printing system 100 (shown in FIG. 1), is shown. As shown with box 210, the method 200 includes consuming printing fluid from a printing fluid reservoir, e.g., the printing fluid reservoir 104 (shown in FIG. 1), by printing. It is contemplated that the printing fluid be consumed by depositing the printing fluid on a medium, e.g., the substrate 30 (shown in FIG. 1), using a printing fluid printing system.

As shown with box 222, a determination is made as to whether a printing fluid refill bottle, e.g., the printing fluid refill bottle 10 (shown in FIG. 2), is seated on a bottle seat of the printing system, e.g., the bottle seat 108 (shown in FIG. 1). The determination can be made, for example, using a signal provided by a bottle-detect sensor, e.g., the bottle-detect sensor 110 (shown in FIG. 1).

When no printing fluid refill bottle is detected as being present at the bottle seat a printing fluid pump of the printing system, e.g., the printing fluid pump 114 (shown in FIG. 1), is operated (i.e. driven) at a first pumping speed, e.g., the first pump speed 32 (shown in FIG. 1). It is contemplated that the first pumping speed be selected such that the printing system continue to consume printing fluid during application of the printing fluid on the substrate(s), as shown with arrow 232.

When the printing fluid refill bottle is detected as present at the bottle seat the printing fluid pump is driven at a second pumping speed, as shown with box 240. With the printing fluid pump operating at the second pumping speed the printing system receives refill printing fluid at a charging port, e.g., the charging port 146 (shown in FIG. 1), as shown with box 250. The refill printing fluid is conveyed through an interior of a housing of the printing system, e.g., the interior 124 (shown in FIG. 1) of the housing 102 (shown in FIG. 1) and communicated to the printing fluid reservoir, as shown with box 262.

It is contemplated that the charging continues until the signal 20 from the printing fluid level sensor 106 indicates that the printing fluid reservoir has reached a predetermined fill level, the printing fluid refill bottle is empty, and/or that the printing fluid refill bottle has been removed from the bottle seat, as shown with arrow 270. Printing thereafter resumes, as shown with box 210. It is also contemplated that, in event that the printing fluid reservoir becomes overfilled, that the overfill condition can be corrected. For example, printing fluid can be returned to a printing fluid refill bottle, as shown with box 262. Alternatively (or additionally), printing fluid can be purged from the printing system with a purge flow issued from a print engine, e.g., the print head assembly 120 (shown in FIG. 2), as shown with box 264.

The processes and operations shown in FIG. 6 are illustrative of an example of a method in accordance with the present disclosure. As will be appreciated in view of the present disclosure, additional processes and/or operations may be added, removed, modified, and/or rearranged without departing from the scope of the present disclosure.

It should be emphasized that the above-described examples are merely possible examples of implementations and set forth for a clear understanding of the present disclosure. Many variations and modifications may be made to the above-described examples without departing substantially from the principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or processes are intended to be supported by the present disclosure.

What is claimed is:

1. A printing system, comprising:
a housing with an interior;
a printing fluid reservoir arranged within the interior housing;
a charging conduit fluidly coupled to the printing fluid reservoir; and
a bottle seat fixed to the housing and defining a charging port, wherein the charging conduit fluidly couples the charging port to the printing fluid reservoir to convey refill printing fluid received at the charging port through the interior of the housing and therethrough to the printing fluid reservoir.

2. The printing system of claim 1, wherein the bottle seat further defines a vent port, wherein the vent port is in fluid communication with the printing fluid reservoir, and wherein the vent port is co-located with the charging port.

3. The printing system of claim 2, further comprising a vent conduit extending through the interior of the housing fluidly coupling the vent port to the printing fluid reservoir.

4. The printing system of claim 2, further comprising a printing fluid refill bottle seated on the bottle seat, wherein the charging port is in fluid communication with an interior of the printing fluid refill bottle, and wherein the vent port is in fluid communication with the interior of the printing fluid refill bottle.

5. The printing system of claim 1, further comprising a bottle-detect sensor fixed in the housing and operably associated with the bottle seat.

6. The printing system of claim 1, further comprising a printing fluid pump fluidly coupling the charging port with the printing fluid reservoir through the charging conduit.

7. The printing system of claim 6, further comprising:
a suction-side union fluidly coupling the charging port to the printing fluid pump;
a supply conduit fluidly coupling the printing fluid reservoir to the suction-side union, and therethrough to the printing fluid pump; and
a pressure-side union fluidly coupling the printing fluid pump to the printing fluid reservoir.

8. The printing system of claim 6, further comprising a print head assembly fluidly coupled to the charging port through the printing fluid pump.

9. The printing system of claim 1, wherein the bottle seat defines a vent port, the printing system further comprising a closure movable relative to the bottle seat between a first position and a second position, wherein the vent port is in fluid communication with an external environment in the both the first position and the second position.

10. The printing system of claim 9, wherein the closure fluidly separates the charging port from the external environment in the first position, wherein the charging port is in fluid communication with the external environment in the second position.

11. The printing system of claim 1, further comprising:
a printing fluid pump fluidly coupling the charging port to the printing fluid reservoir;
a print head assembly fluidly coupled to the printing fluid reservoir through the printing fluid pump; and
a controller with a processor operably connected to the printing fluid reservoir and disposed in communication with a memory having instructions that cause the processor to:
determine whether a printing fluid refill bottle is seated on the bottle seat;
drive the printing fluid pump at a first pump speed when no printing fluid refill bottle is present at the charging port to communicate printing fluid to the print head assembly; and
drive the printing fluid pump at a second pump speed when a printing fluid refill bottle is present at the charging port to communicate refill printing fluid to the printing fluid reservoir.

12. The printing system of claim 11, further comprising a bottle-detect sensor that is co-located with the charging port and is disposed in communication with the processor, wherein the instructions further cause the controller to receive a bottle-present signal from the bottle-detect sensor.

13. The printing system of claim 11, wherein the processor is operably connected to the print head assembly, wherein the instructions further cause the processor to cease operation of the print head assembly when a bottle is present at the charging port.

14. A method of adding printing fluid to a printing system, comprising:
receiving refill printing fluid at a charging port of a printing system having a housing with an interior, an printing fluid reservoir arranged within the interior of the housing, the charging conduit fluidly coupled to the printing fluid reservoir, and a bottle seat fixed to the housing and defining a charging port, the charging conduit fluidly coupling the charging port to the printing fluid reservoir; and
conveying the refill printing fluid through the interior of the housing and therethrough to the printing fluid reservoir.

15. The method of claim 14, further comprising:
determining whether a printing fluid refill bottle is seated on the bottle seat;
driving a printing fluid pump at a first pump speed when no printing fluid refill bottle is present at the charging port to communicate printing fluid to a print head assembly;
driving the printing fluid pump at a second pump speed when a printing fluid refill bottle is present at the charging port to communicate refill printing fluid to the printing fluid reservoir, wherein the second pump speed is greater than the first pump speed;
returning printing fluid to the printing fluid refill bottle; and
purging printing fluid from the printing system through a print engine.
